(19) United States
(12) Patent Application Publication
(10) Pub. No.: US 2005/0000415 A1
(43) Pub. Date: Jan. 6, 2005

(54) Adhesive transfer roller of an adhesive application device

(76) Inventor: Peter Sieweke, Bielefeld (DE)

Correspondence Address: JACOBSON HOLMAN PLLC, 400 SEVENTH STREET N.W., SUITE 600, WASHINGTON, DC, 20004, US

(21) Appl. No.: 10/836,238

(22) Filed: May 3, 2004

(30) Foreign Application Priority Data
May 2, 2003 (DE) 103 19 658.7

(51) Int. Cl. B05C 1/00; B65C 9/00

(52) U.S. Cl. 118/200; 118/209

(57) ABSTRACT

The invention relates to an adhesive transfer roller (1) of an adhesive application device, preferably in a tube extruding machine, to transfer adhesive to a sizing roller, whereby the adhesive transfer roller (1) is mounted with bearings in lever arms (6, 10) so that it can rotate, it being possible to use these lever arms (6, 10) so that the adhesive transfer roller (1) can be moved toward and away from the sizing roller and whereby the lever arms (6, 10) are mounted so that they can rotate in the machine frame, beyond the side walls (2) of which the adhesive transfer roller (1) extends.

The invention is characterized in that the bearings (5), with which the adhesive transfer roller (1) is mounted in the lever arms (6, 10), are accessible from the outside of the machine frame side walls (2).

The invention relates to an adhesive transfer roller of an adhesive application device, preferably in a tube extruding machine, according to the preamble of claim 1.

In known adhesive application devices in tube extruding machines, as shown for example in EP 0 546 286 B1, adhesive transfer rollers are frequently used, which form an adhesive slot with at least one other roller (frequently a sealing roller). To the sides of the rollers, sealing plates are arranged, which create a pan into which the adhesive is poured. The adhesive transfer roller has a direction of rotation such that it picks up adhesive through the slot and transfers it to a sizing roller.

The adhesive transfer rollers of the known adhesive application devices are mounted with bearings in lever arms so that they can rotate. These lever arms are used to move the adhesive transfer roller toward and away from the sizing roller. For this purpose, the lever arms are mounted on the inside on the side walls of the machine frame.

Since in spite of the sealing plates at the face sides of the rollers, escape of adhesive can not be prevented completely, adhesive gets into the bearings used to mount the adhesive transfer roller in the lever arms. Because of this it is necessary to replace the bearings frequently. However, what has proven to be disadvantageous is that in order to replace the bearings, the adhesive transfer roller has to be removed from the area between the side walls of the machine frame.

The object of the present invention is thus to suggest an adhesive transfer roller that does not have to be removed from the machine frame for the purpose of replacing the bearing.

According to the invention, this object is achieved by the characteristics of the identifying part of claim 1.

According to this, the bearing with which the adhesive transfer roller is mounted in the lever arms is accessible from the outside of the side walls of the machine frame. In this way, the bearings can be pulled from the face-side bearing neck of the adhesive transfer roller from the outside. During the bearing replacement, the adhesive transfer roller can be supported in the holes in the side walls of the machine frame or on special brackets.

It is especially advantageous here if at least one of the lever arms is mounted on the side of the machine frame side wall that holds the lever arm that is turned away from the adhesive transfer roller. In this case, all that has to be removed is the fastener with which the lever arm is fastened in the side wall. Then the entire lever arm, including the bearing, can be pulled from the adhesive transfer roller neck and the bearing can be replaced.

In a preferred embodiment of the invention, on at least one face-side end, the adhesive transfer roller comprises a neck that is mounted so that it can be removed, with which the adhesive transfer roller is mounted in one of the lever arms. In this embodiment, the lever arm can be mounted on the inside on the side wall that holds it. The adhesive transfer roller neck can be removed through a hole in the side wall so that the bearing is freely accessible. Since the neck and the bearing usually have a very tight connection, the neck and the bearing can be removed simultaneously and separated from each other elsewhere.

It is especially advantageous here if the neck is fastened to the face-side end of the adhesive transfer roller with a screw.

An embodiment example of the invention can be found in the drawings and the objective description. However, it should be mentioned that the invention does not have to be restricted only to a adhesive transfer roller of an adhesive application device but can be extended to all rollers in adhesive application devices that are mounted through side walls of a machine frame.

In the individual figures:

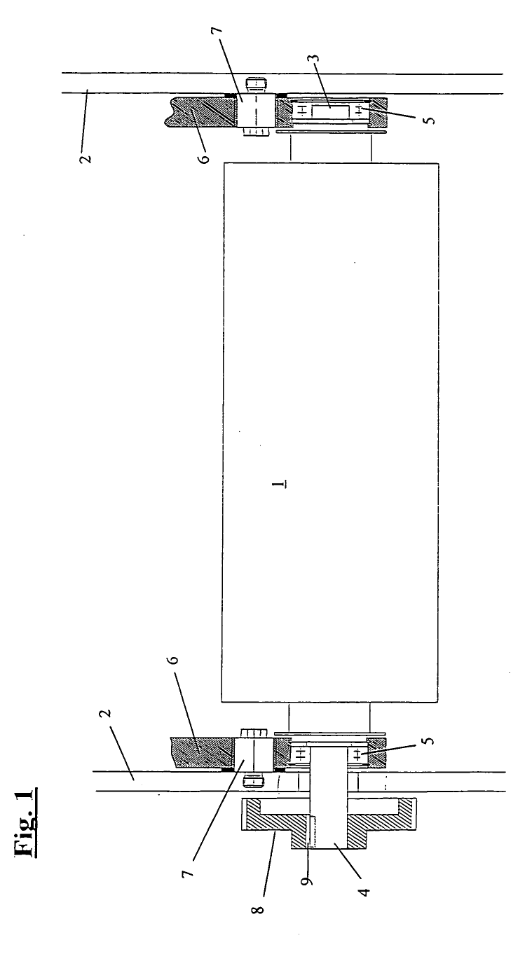

FIG. 1 shows a top view of a adhesive transfer roller according to the state of the art

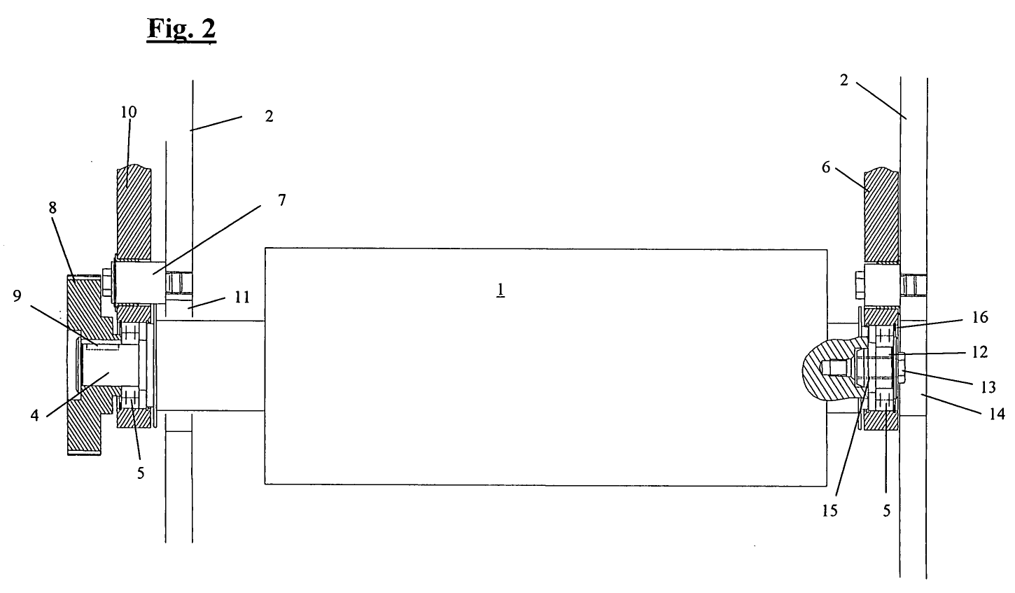

FIG. 2 shows an adhesive transfer roller according to the invention.

FIG. 1 shows an adhesive transfer roller 1 that runs crosswise between two side walls 2 of a machine frame. The face-side bearing necks 3, 4 of the adhesive transfer roller 1 are mounted in the lever arms 6 by way of bearings 5. The lever arms 6 are mounted on bearing pins 7 that can be screwed into the insides of side walls 2 so that the adhesive transfer roller 1 can be swiveled. The bearing neck 4 of the adhesive transfer roller 1 passes through a hole in one of the side walls 2 of the machine frame. On this bearing neck 4, a drive gear 8 is mounted, with form fit, by means of a spring key 9 so that the drive gear 8 that is moved in rotation by a pulling means, say a toothed belt, can transfer a torque to the adhesive transfer roller 1. If the bearings 5 will now be replaced, first the drive gear 8 has to be removed. Then the bearing pins 7 are removed. After that, the adhesive transfer roller 1, together with the lever arms 6, can be removed from the area between side walls 2. Only then are the bearings 5 accessible.

FIG. 2 also shows a adhesive transfer roller 1 that runs crosswise between two side walls 2 of a machine frame. The bearing neck 4 of the adhesive transfer roller 1 is mounted in lever arm 10.

Lever arm 10 is mounted on the outside on side wall 2. On the end of the bearing neck 4, drive gear 8 is mounted in a known way using a spring key 9. To replace the bearing 5, first the drive gear 8 has to be removed. Then the bearing pin 7 can be loosened from side wall 2. Now lever arm 10 can be pulled from bearing neck 4. Then the bearing 5 is freely accessible for the purpose of replacement. During this time, the adhesive transfer roller supports itself on side wall 2 in the area of hole 11.

The opposite end of the adhesive transfer roller 1 is mounted with its bearing neck 12 in the bearing 5 in lever arm 6, whereby lever arm 6 is mounted in a known way on the inside on side wall 2. Bearing neck 12 is connected to adhesive transfer roller 1 on the face side and coaxially with screw 13. For the purpose of replacing bearing 5, first the screw 13 is removed. After the Seeger circlip 16 is removed, a screw with larger diameter, which is not shown, is screwed into the thread 15 and after a few turns supports itself on the face side of the adhesive transfer roller 1 so that when this screw is turned further, the bearing neck 12 and the bearing 5 are pulled out of the lever arm 6. Both components can be removed from the outside through hole 14 without the adhesive transfer roller 1 having to be removed from the area between the side walls 2 of the machine frame.

### Reference Character List

1 Adhesive transfer roller
2 Side wall of the machine frame
3 Bearing neck
4 Bearing neck
5 Bearing
6 Lever arm
7 Bearing pin
8 Drive gear
9 Spring key
10 Lever arm
11 Hole
12 Bearing neck
13 Screw
14 Hole
15 Thread
16 Seeger circlip
17
18
19
20
21
22
23
24

1. Adhesive transfer roller (1) of an adhesive application device, preferably in a tube extruding machine, to transfer adhesive to a sizing roller, whereby the adhesive transfer roller (1) is mounted with bearings in lever arms (6, 10) so that they can rotate, it being possible to use these lever arms (6, 10) so that the adhesive transfer roller (1) can be moved toward and away from the sizing roller and whereby the lever arms (6, 10) are mounted so that they can rotate in the machine frame, beyond the side walls (2) of which the adhesive transfer roller (1) extends
characterized in that
the bearings (5), with which the adhesive transfer roller (1) is mounted in the lever arms (6, 10) are accessible from the outside of the machine frame side walls (2).

2. Adhesive transfer roller (1) according to claim 1
characterized in that
at least one of the lever arms (6, 10) is mounted on the side of the machine side wall (2) that holds the lever arm (6, 10) turned away from the adhesive transfer roller (1).

3. Adhesive transfer roller (1) according to claim 1 or 2
characterized in that
the adhesive transfer roller (1) comprises, on at least one face-side end, a neck (12) that is fastened so that it can be removed, with which the adhesive transfer roller (1) is mounted in one of the lever arms (6, 10).

4. Adhesive transfer roller (1) according to claim 3
characterized in that
the neck is fastened on the face-side end of the adhesive transfer roller (1) with a screw (13).
